(19) United States
(12) Patent Application Publication
(10) Pub. No.: US 2017/0369240 A1
(43) Pub. Date: Dec. 28, 2017

(54) FRONT OPERATING REFUSE LINER REMOVAL SYSTEM

(71) Applicants: Stephanie Michelle Soule, Weatherford, TX (US); Jason Soule, Weatherford, TX (US); Betty J. O'Bannon, Willow Park, TX (US); Raymond William O'Bannon, Willow Park, TX (US)

(72) Inventors: Stephanie Michelle Soule, Weatherford, TX (US); Jason Soule, Weatherford, TX (US); Betty J. O'Bannon, Willow Park, TX (US); Raymond William O'Bannon, Willow Park, TX (US)

(21) Appl. No.: 15/428,764

(22) Filed: Feb. 9, 2017

Related U.S. Application Data
(60) Provisional application No. 62/353,616, filed on Jun. 23, 2016.

(51) Int. Cl. B65F 1/06

(52) U.S. Cl. CPC B65F 1/06

(57) ABSTRACT

A front operating refuse liner removal system includes a refuse receptacle with an access opening closed by a door. The access opening enables a user to efficiently remove a liner from the receptacle without creating suction between the liner and the receptacle. The door opens by sliding along a track on the inside the receptacle so as not to obstruct the user while removing the liner.

### BACKGROUND

### 1. Field of the Invention

The present invention relates generally to refuse receptacls, and more specifically, to a refuse liner removal system for enabling the removal of bags filled with waste from the waste receptacle.

### 2. Description of Related Art

Refuse receptacles are well known in the art and are effective means to hold a refuse liner to be filled with waste. For example, FIG. 1 depicts a conventional refuse liner removal system 101 having a refuse receptacle 105 supporting a refuse liner 107 that is filled with waste 109. During use, a user 103 pulls up on liner 107 removing it and the waste 109 from the refuse receptacle 105.

One of the problems commonly associated with system 101 is its limited use. For example, a liner 107 filled with waste 109 can create a seal within the receptacle 105 making it difficult to remove the liner 107 from the receptacle 105.

Accordingly, although great strides have been made in the area of refuse liner removal systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a common refuse liner removal system;

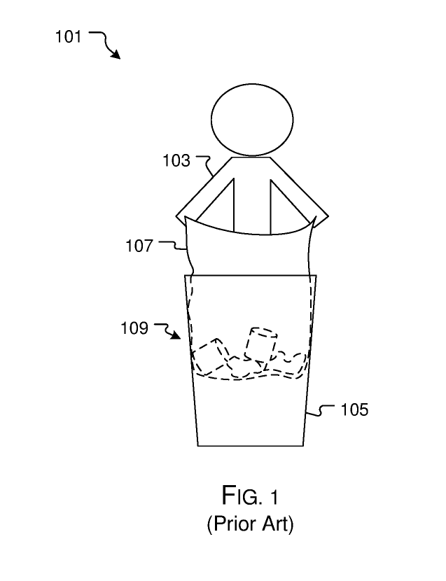

FIGS. 2A, 2B and 2C are front views of a front operating refuse liner removal system in accordance with a preferred embodiment of the present application; and

FIGS. 3A and 3B are sectional top views of the receptacle of FIGS. 2A, 2B and 2C.

FIG. 4 is a diagram of the preferred method of use of the system of FIGS. 2A, 2B and 2C.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional refuse liner removal systems. Specifically, the system of the present application eliminates the creation of a seal between the liner and the receptacle facilitating removal of a liner. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

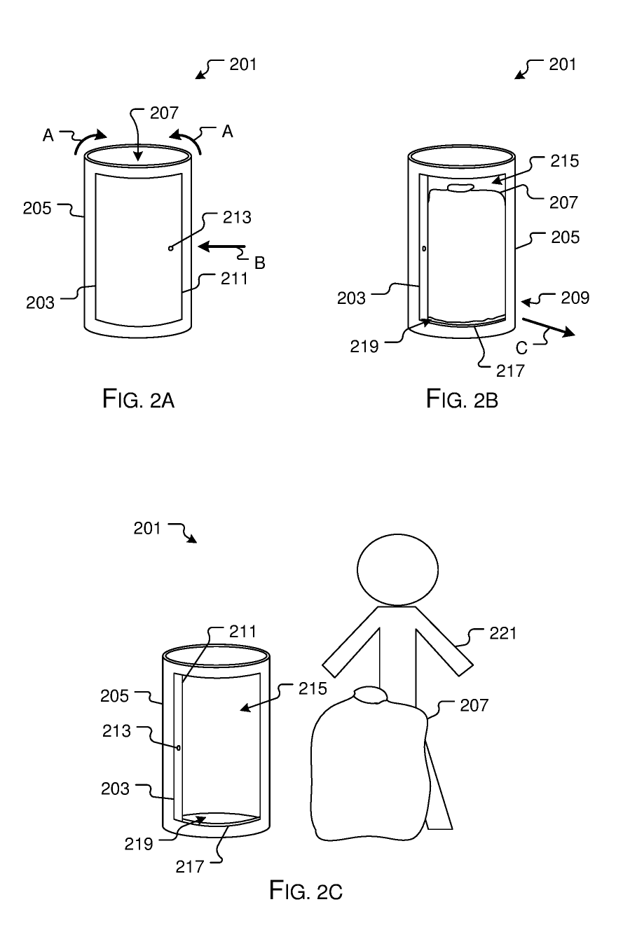

Referring now to the drawings wherein like reference characters identify corresponding or similar elements throughout the several views, FIGS. 2A, 2B and 2C depict front views of a front operating refuse liner removal system 201 in accordance with a preferred embodiment of the present application. It will be appreciated that system 201 overcomes one or more of the above-listed problems commonly associated with conventional refuse liner removal systems.

In the contemplated embodiment, system 201 includes a refuse receptacle 205 having an access opening 203 that penetrates the receptacle 203. The access opening 203 having a door 211 slidingly attached to the receptacle. The door 211 having a handle 213 rigidly attached that facilitates moving the door 211 to open and close the access opening 203.

The receptacle having an interior compartment 215 within configured to support a liner 207. The interior compartment 215 having a track 217 integral to at least the bottom surface 219 and configured to facilitate the door 211 sliding open and closed.

In use the liner 207 is filled with refuse 209. To remove the liner 207, door 211 transits along track 217 by applying force to handle 213 as depicted by motion B. A user 221 closes liner 207 within the interior compartment 215 as depicted by motions A. The liner 207 is then extracted from the interior compartment 215 via door 211 as depicted by motion C.

It should be appreciated that one of the unique features believed characteristic of the present application is that door 211 opens receptacle 205 without becoming an obstacle for user 221 to work around as they remove refuse liner 207 from the receptacle. It will also be appreciated that track 217 allows door 211 to smoothly transit within the interior or receptacle 205. It will also be appreciated that lids, foot operated doors, liner retainers and other features common to refuse receptacles could be incorporated with system 201 without deviating from this disclosure.

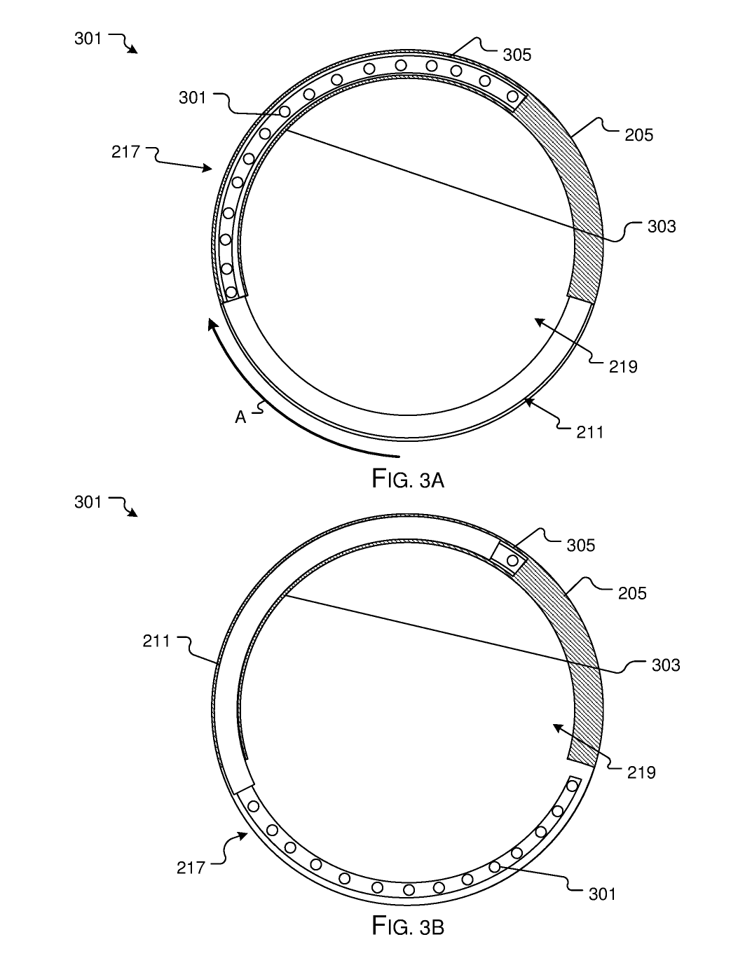

Referring now to FIGS. 3A and 3B an alternate embodiment of the system 201 of FIGS. 2A, 2B and 2C is depicted. The embodiment 301 having the features of system 201 with an additional interior wall 303 forming a space 305 where door 211 can travel as it opens. It will be appreciated that interior wall 303 protects the door 211 and track 217 from fouling with the liner 207 or refuse 209. It will also be appreciated that while track 217 is depicted with ball bearings 307 that any method of facilitating the movement of door 211 is contemplated. It will also be appreciated that while receptacle 205 is depicted as a circle any shape is contemplated so long as door 211 opens on the within the receptacle 205 as depicted by motion A.

Another unique feature believed characteristic of the present application is interior wall 303 that prevents liner 207, refuse 209 or any other foreign item from obstructing the movement of door 211.

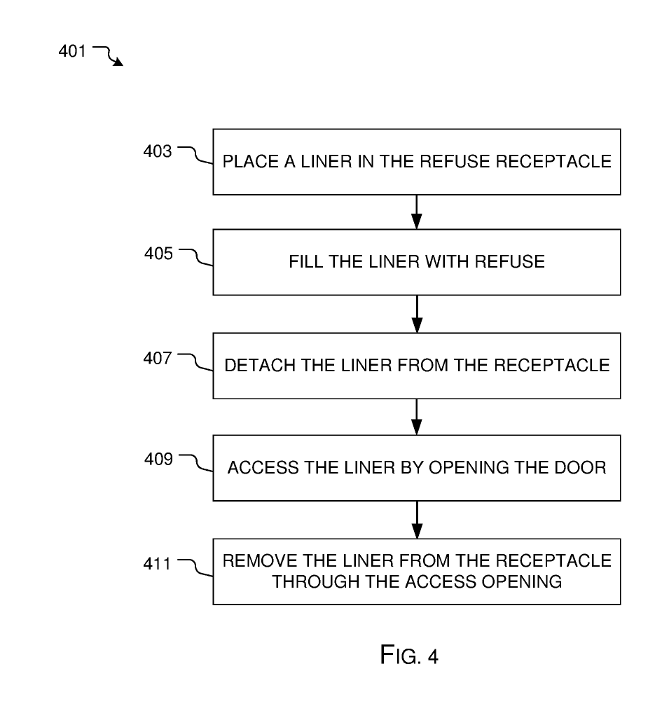

Referring now to FIG. 4 the preferred method of use of system 201 is depicted, method 401 including, placing a liner in the refuse receptacle 403, filling the liner with refuse 405, detaching the liner from the receptacle 407, accessing the liner by opening the door 409 and removing the liner from the receptacle through the door 411.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A front operating refuse liner removal system, comprising:
a refuse receptacle configured to support a liner in an interior compartment;
the receptacle also having an access opening through which the liner is removed;
a door slidingly attached to the receptacle that closes and opens the access opening; and
a track integral to at least a bottom surface of the interior compartment;
wherein the door open by sliding inside the interior compartment.

2. The system of claim 1 wherein the receptacle comprises an interior wall that creates a space between itself and the receptacle separate from the interior compartment wherein the door can travel when sliding open.

3. The track of claim 1 wherein ball bearings are attached to facilitate the door sliding open.

4. The door of claim 1 wherein the door comprises a handle to facilitate opening the door.

5. The system of claim 1 wherein the receptacle is a circular canister.

6. The system of claim 1 wherein the receptacle is an oval canister.

7. The system of claim 1 wherein the receptacle is rectangular.

8. The method of removing a liner from a refuse receptacle given the system of claim 1 comprising:
placing a liner in the refuse receptacle;
filling the liner with refuse;
detaching the liner from the receptacle;
accessing the liner by opening the door; and
removing the liner from the receptacle through the door.
